(19) United States
(12) Patent Application Publication
(10) Pub. No.: US 2018/0056555 A1
(43) Pub. Date: Mar. 1, 2018

(54) Method of Making Foam Wall Panel

(71) Applicant: Yang Ko Industrial Co., Ltd., Taipei City (TW)

(72) Inventor: Chih-Wen Chiang, Taipei City (TW)

(21) Appl. No.: 15/783,182

(22) Filed: Oct. 13, 2017

Related U.S. Application Data
(63) Continuation-in-part of application No. 15/246,602, filed on Aug. 25, 2016.

(51) Int. Cl. B29C 44/14; B29C 44/58; E04F 13/08

(52) U.S. Cl. CPC B29C 44/14; B29K 2075/00; E04F 13/0866; B29C 44/58

(57) ABSTRACT

A foam wall panel contains: a prepolymer PU leather layer and a polyurethane (PU) foaming substrate. The prepolymer PU leather layer has a thickness of 0.2 mm to 0.5 mm, and the PU foaming substrate has a density of 0.2 g/cm³ to 0.29 g/cm³. A foam mold is configured to melt and to adhere the prepolymer PU leather layer with a part of the PU foaming substrate so as to form a body, and a thickness of a cross section of the PU foaming substrate is within 0.5 cm to 2 cm. A holder has a cavity, a first radian, multiple orifices, and an air channel, wherein the air channel has successive arcuations arranged therein so as to exhaust air and to accommodate the part of the PU foaming substrate. A cover is rotatably connected with a first end of the holder, and the cover includes a second radian corresponding to the cavity.

This application is a Continuation-in-Part of application Ser. No. 15/246,602, filed on Aug. 25, 2016.

### BACKGROUND OF THE INVENTION

### Field of the Invention

The present invention relates to a method of making a foam wall panel which is thin and is manufactured easily.

### Description of the Prior Art

Typically, a peripheral wall in a building is decorated by using a variety of wall panels made of wood, leather, fabric or firewood material, wherein the wall panels are cut according to using requirements and then are adhered or nailed on the peripheral wall. However, such construction process is time-consuming and expensive.

Referring to FIG. 1, a conventional foam wall panel contains a polyurethane (PU) synthetic leather 10 and a polyurethane (PU) foaming substrate 20, and each of the PU synthetic leather 10 and the PU foaming substrate 20 is thick. A foam mold is configured to foam mold the PU synthetic leather 10 and the PU foaming substrate, the foam mold has a flat mold part, and the wall panel is curved because of its flexibly. Thus, the wall panel cannot be adhered on the peripheral wall matingly.

The present invention has arisen to mitigate and/or obviate the afore-described disadvantages.

### SUMMARY OF THE INVENTION

The primary objective of the present invention is to provide a method of making a foam wall panel which is foam molded quickly so as to reduce fabrication cost and is lightweight and flexible so as to cut into desired shape easily.

Secondary objective of the present invention is to provide a method of making a foam wall panel which is capable of decorating the peripheral wall, and the prepolymer PU leather layer is thinner and more flexible than PU synthetic leather.

Further objective of the present invention is to provide a method of making a foam wall panel which contains the prepolymer PU leather layer and the PU foaming substrate matingly adhered with the prepolymer PU leather layer.

Another objective of the present invention is to provide a method of making a foam wall panel in which the prepolymer PU leather layer or the PU foaming substrate does not wrinkle or does not protrude.

Preferably, a part of the body is cut by the cutter so as to form a cut portion which is adhered on the peripheral wall based on using requirements.

To obtain above-mentioned objectives, a method of making a foam wall panel provided by the present invention contains: melting and adhering a prepolymer PU leather layer with a peripheral fence and a top of a polyurethane (PU) foaming substrate by using a foam mold so as to form a body in a geometry shape and with a thin thickness.

Preferably, the prepolymer PU leather layer has a thickness of 0.2 mm to 0.5 mm.

Preferably, the polyurethane (PU) foaming substrate has a density of 0.2 g/cm³ to 0.29 g/cm³.

Preferably, the PU foaming substrate is within 0.5 cm to 2 cm after the foam wall panel is formed.

Preferably, the foam mold includes a holder which has a cavity defined on a central portion thereof a first radian formed on a bottom of the cavity, a plurality of orifices arranged under the bottom of the cavity, and an air channel surrounding the cavity, wherein the air channel has successive arcuation arranged therein so as to exhaust air and to accommodate a part of the PU foaming substrate.

Preferably, a cover is rotatably connected with a first end of the holder, and the cover includes a second radian corresponding to the cavity, when foam molding the body, the plurality of orifices suck the prepolymer PU leather layer on the bottom of the cavity, and the first radian and the second radian correspond to a deformation of the PU foaming substrate, such that a first surface of the body corresponds to the first radian and a second surface of the body corresponds to the second radian so as to compensate the deformation of the PU foaming substrate.

### BRIEF DESCRIPTION OF THE DRAWINGS

FIG. 1 is a diagram of a conventional foam wall panel.

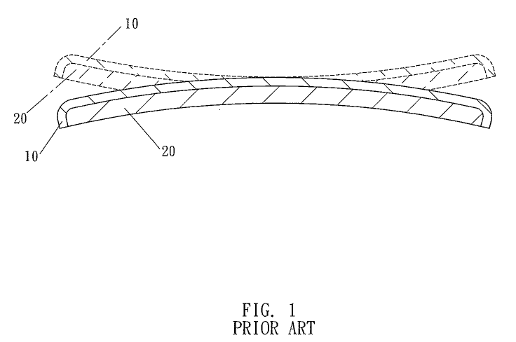

FIG. 2 is a perspective view showing the assembly of a foam wall panel according to a preferred embodiment of the present invention.

FIG. 3 is a perspective view showing the exploded components of the foam wall panel according to the preferred embodiment of the present invention.

FIG. 4 is a cress-sectional perspective view showing the assembly of the foam wall panel according to the preferred embodiment of the present invention.

FIG. 5 is a perspective view showing the operation of a foam mold according to the preferred embodiment of the present invention.

FIG. 6 is a cross sectional view showing the assembly of the foam mold according to the preferred embodiment of the present invention.

FIG. 7 is an amplified cross sectional view showing the assembly of a part of the foam mold according to the preferred embodiment of the present invention.

FIG. 8 is another perspective view showing the operation of the foam mold according to the preferred embodiment of the present invention.

FIG. 9 is a cross sectional view showing the operation of a part of the foam mold according to the preferred embodiment of the present invention.

FIG. 10 is also another perspective view showing the operation of the foam mold according to the preferred embodiment of the present invention.

FIG. 11 is still another perspective view showing the operation of the foam mold according to the preferred embodiment of the present invention.

FIG. 12 is another perspective view showing the operation of the foam mold according to the preferred embodiment of the present invention.

FIG. 13 is a cross sectional view showing the operation of the foam wall panel according to the preferred embodiment of the present invention.

FIG. 14 is a perspective view showing the application of the foam wall panel according to the preferred embodiment of the present invention.

### DETAILED DESCRIPTION OF THE PREFERRED EMBODIMENTS

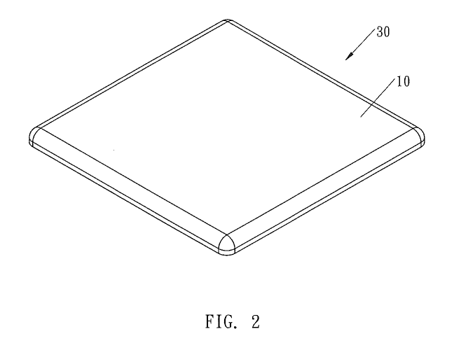

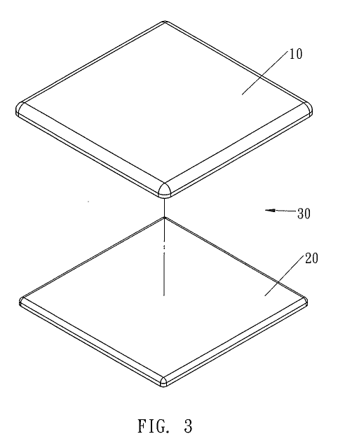

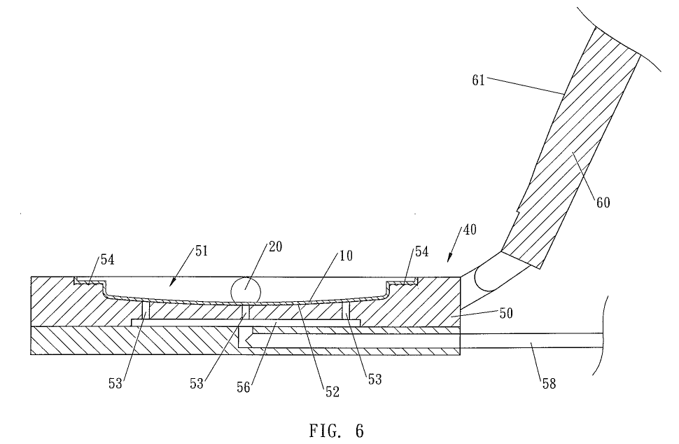

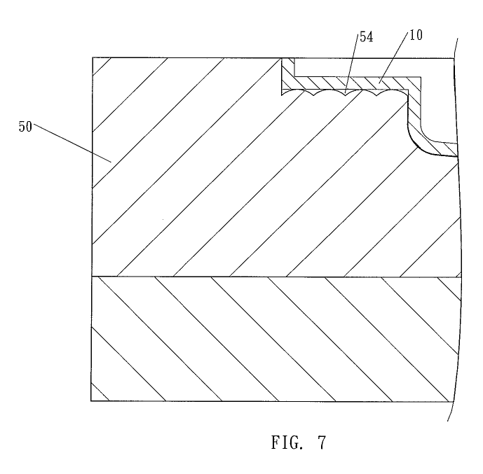

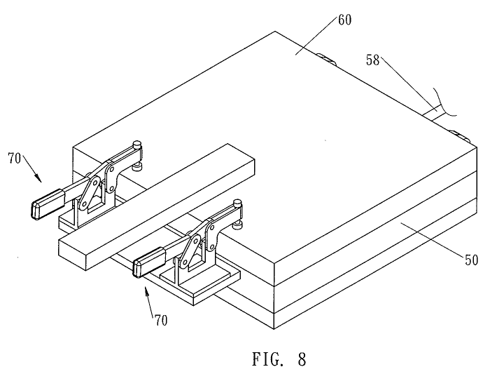

Referring to FIGS. 2-8, a method of making a foam wall panel according to a preferred embodiment of the present invention, the foam wall panel comprises: a body 30 which includes a prepolymer PU leather layer 10 and a polyurethane (PU) foaming substrate 20.

The prepolymer PU leather layer 10 has a thickness of 0.2 mm to 0.5 mm.

The PU foaming substrate 20 has a density of 0.2 g/cm³ to 0.29 g/cm³.

A foam mold 40 is configured to melt and to adhere the prepolymer PU leather layer 10 with a peripheral fence and a top of the PU foaming substrate 20 so as to form the body 30 in a geometry shape and with a thin thickness, wherein a thickness of a cross section of the PU foaming substrate 20 is within 0.5 cm to 2 cm. The foam mold 40 includes a holder 50 and a cover 60, and the foam mold 40 is heated at a temperature of 30° C. to 40° C.

The holder 50 has a cavity 51 defined on a central portion thereof, a first radian 52 formed on a bottom of the cavity 51, a plurality of orifices 53 arranged under the bottom of the cavity 51, and an air channel 54 surrounding the cavity 51, wherein the air channel 54 has successive arcuation arranged therein so as to exhaust air and to accommodate a part of the PU foaming substrate 20.

The cover 60 is rotatably connected with a first end of the holder 50, and the cover 60 includes a second radian 61 corresponding to the cavity 51. Thereby, when foam molding the body 30, the plurality of orifices 53 are vacuumed by a vacuum apparatus (not shown) so as to suck the prepolymer PU leather layer 10 on the bottom of the cavity 51, and the first radian 52 and the second radian 61 correspond to a deformation of the PU foaming substrate 20, such that a first surface of the body 30 corresponds to the first radian 52 and a second surface of the body 30 corresponds to the second radian 61 so as to compensate the deformation of the PU foaming substrate 20.

A depth of the air channel 54 corresponds to the thickness of the prepolymer PU leather layer 10 of the body 30.

The foam mold 40 further includes a groove 56 formed in the holder 50 and communicating with the plurality of orifices 53, and the groove 56 is in connection with a first end of a guide tube 58, wherein a second end of the guide tube 58 is coupled with the vacuum apparatus (not shown).

The foam mold 40 further includes a first fixture 70 disposed on a second end of the holder 50 opposite to the first end of the holder 50 and configured to fix the cover 60, after the cover 60 covers the holder 50.

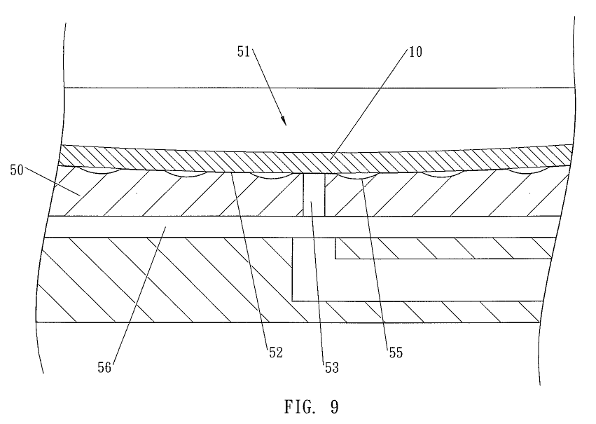

Referring to FIG. 9, the cavity 51 has a pattern section 55 formed on the bottom thereof and a depth of the pattern section 55 is within 0.5 mm to 2 mm.

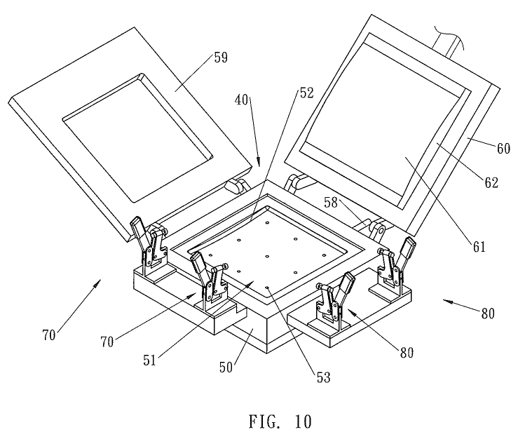

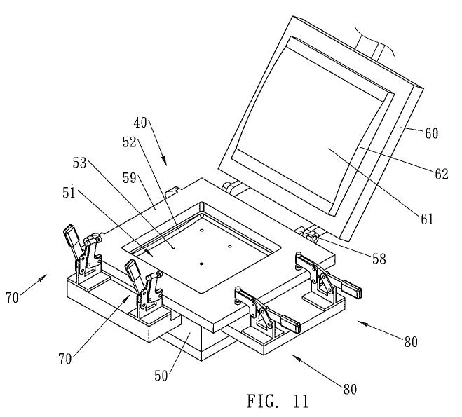

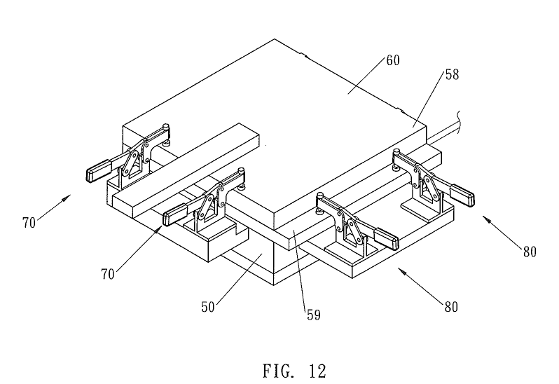

As illustrated in FIGS. 10 to 12, the foam mold 40 further includes a press flange 59 rotatably connected with a first peripheral side of the holder 50 between the first end and the second end of the holder 50, and a shape of the press flange 59 corresponds to a peripheral portion of a top of the holder 50 adjacent to a top of the cavity 51 so that the press flange 59 covers and presses the peripheral portion of the top of the holder 50. The cover 60 also includes a protrusion 62 arranged on a bottom thereof and the second radian 61 forms on the protrusion 62.

The foam mold 40 further includes a second fixture 80 mounted on a second peripheral side of the holder 50 opposite to the first peripheral side of the holder 50 so as to clamp the press flange 59, after the press flange 59 covers the holder 50.

A method of foam molding the foam wall panel comprises: steps ofA, B, C, and D.

In the step of A, the holder 50 is heated at the temperature of 30° C. to 40° C. in an electronic controlling manner, and the prepolymer PU leather layer 10 is placed on the cavity 51 of the holder 50, wherein a thickness of the prepolymer PU leather layer 10 is within 0.2 mm to 0.5 mm, an area of the prepolymer PU leather layer 10 is more than that of the cavity 51 so that the prepolymer PU leather layer 10 covers the air channel 54, and the vacuum apparatus (not shown) is started so as to draw air in the cavity 51 via the plurality of orifices 53, hence the prepolymer PU leather layer 10 adheres on the bottom of the cavity 51.

In the step of B, the PU foaming substrate 20 is liquid and is added to the prepolymer PU leather layer 10, wherein a volume of the PU foaming substrate 20 is identical to that of the cavity 51, a density of the PU foaming substrate 20 is within 0.2 g/cm³ to 0.29 g/cm³, and the cover 60 covers the holder 50 so that the PU foaming substrate 20 is foam molded in the foam mold 40 and contacts the cover 60, wherein a shape of the body 30 corresponds to a molding space between the cavity 51 and the cover 60. Thereafter, the body 30 is cooled, the vacuum apparatus (not shown) is turned off, and the cover 60 is uncovered from the holder 50 so as to remove the body 30 from the holder 50, wherein the body 30 includes the prepolymer PU leather layer 10 and the PU foaming substrate 20 adhered with the prepolymer PU leather layer 10.

In the step of C, the body 30 is curved, i.e., the prepolymer PU leather layer 10 corresponds to the first radian 52 of the cavity 51 and has another first radian 52, and the PU foaming substrate 20 corresponds to the second radian 61 of the cover 60 and has another second radian 61, wherein said another first radian 52 of the prepolymer PU leather layer 10 and said another second radian 61 of the PU foaming substrate 20 determines based on a size, a thickness, a density, and a material of the body 30.

In the step of D, a peripheral side of the body 30 is cut and trimmed by a cutter 90, thus finishing the body 30.

The first radian 52 of the holder 50 and the second radian 61 of the cover 60 correspond to the deformation of the PU foaming substrate 20, and the body 30 includes said another first radian 52 of the prepolymer PU leather layer 10 and said another second radian 61 of the PU foaming substrate 20 and causes curved deformation after a period of foam molding time, wherein the curved deformation of the body 30 is offset by said another first radian 52 and said another second radian 61 of the body 30, thus flatting the body 30.

Preferably, the first radian 52 of the holder 50 and the second radian 61 of the cover 60 are adjusted so as to change said another first radian 52 and said another second radian 61 of the body 30, thus obtaining curvature of the body 30.

As foam molding the prepolymer PU leather layer 10 and the PU foaming substrate 20 in the foam mold 40, the holder 50 is heated at the temperature of 30° C. to 40° C. in the electronic controlling manner. Since the foam mold 40 is made of metal, the holder 50 is heated evenly and stably, thus melting and adhering the prepolymer PU leather layer 10 with the PU foaming substrate 20 firmly.

As the PU foaming substrate 20 is foam molded, the air completely exhausts out of the PU foaming substrate 20 via the air channel 54, such that the prepolymer PU leather layer 10 or the PU foaming substrate 20 does not wrinkle or does not protrude.

In case the volume of the PU foaming substrate 20 is more than the cavity 51 after foam molding the PU foaming substrate 20 and placing the PU foaming substrate 20 into the cavity 51, a part of the PU foaming substrate 20 is pushed into the air channel 54, thus reducing the volume of the PU foaming substrate 20 and avoiding deformation of the PU foaming substrate 20.

When the PU foaming substrate 20 inflates in the cavity 51, because the depth of the air channel 54 is more than the thickness of the prepolymer PU leather layer 10, one part of the prepolymer PU leather layer 10 on the air channel 54 is sucked by the plurality of orifices 53 and is not pressed by the cover 60, another part of the prepolymer PU leather layer 10, which deforms, is pushed into the air channel 54, and the other part of the prepolymer PU leather layer 10 in the cavity 51 is flatten, thus foam molding the prepolymer PU leather layer 10 flatly.

As manufacturing the foam mold 40, the pattern section 55 is formed on the bottom of the cavity 51, and the depth of the pattern section 55 is within 0.5 mm to 2 mm, such that when the prepolymer PU leather layer 10 is sucked by the plurality of orifices 53 to contact the bottom of the cavity 51 matingly, and patterns form on the prepolymer PU leather layer 10 and corresponds to the pattern section 55, thus foam molding the foam wall panel with the patterns.

The foam mold 40 further includes the first fixture 70 mounted on the second end of the holder 50 opposite to the first end of the holder 50 and configured to fix the cover 60, after the cover 60 covers the holder 50, thus fixing the cover 60 after the PU foaming substrate 20 inflates.

The foam mold 40 further includes the press flange 59 rotatably connected with the first peripheral side of the holder 50 between the first end and the second end of the holder 50, wherein the press flange 59 covers the peripheral portion of the top of the holder 50 and the air channel 54, thus fixing the prepolymer PU leather layer 10 and the PU foaming substrate 20.

When the prepolymer PU leather layer 10 is placed on the holder 50 and is sucked by the plurality of orifices 53, the press flange 59 covers and presses a peripheral portion of the prepolymer PU leather layer 10 on the air channel 54, thus fixing the prepolymer PU leather layer 10 by using the press flange 59 as the PU foaming substrate 20 inflates. Preferably, the foam wall panel with the patterns is foam molded entirely.

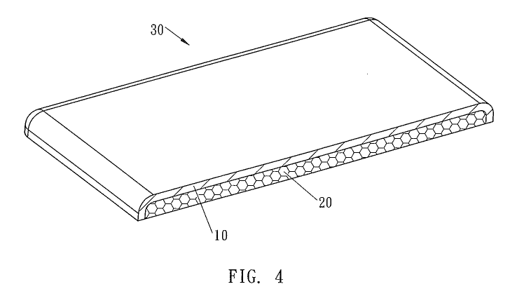

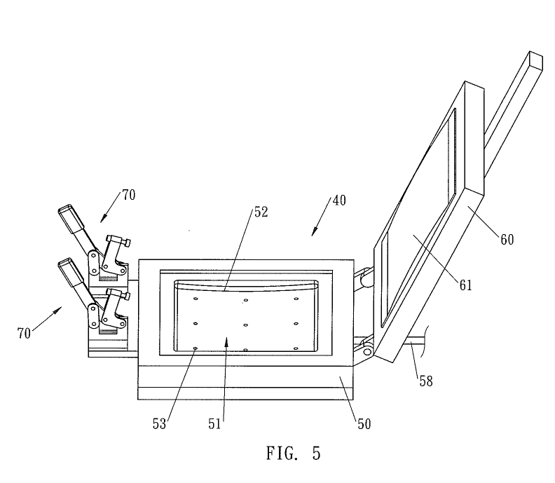

The cover 60 also includes the protrusion 62 arranged on the bottom thereof, and the second radian 61 forms on the protrusion 62, as shown in FIGS. 4 and 5.

In addition, the protrusion 62 does not contact the press flange 59, so when the cover 60 closes the cavity 51, the body 30 is form molded completely.

The foam mold 40 further includes the second fixture 80 mounted on the second peripheral side of the holder 50 opposite to the first peripheral side of the holder 50 so as to fix the press flange 59, after the press flange 59 covers the holder 50, wherein an area of the press flange 59 is more than a contacting zone of the holder 50 and the cover 60, and the second fixture 80 clamps the press flange 59.

Accordingly, the foam wall panel of the present invention contains advantages as follows:

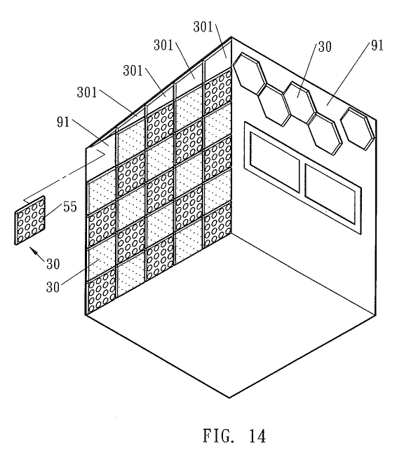

1. Referring to FIG. 14, multiple bodies 30 of various geometry shapes are foam molded quickly so as to reduce fabrication cost. Furthermore, the multiple bodies 30 are lightweight and flexible so as to cut into desired shape easily.

2. As illustrated in FIG. 14, the multiple bodies 30 are adhered on a peripheral wall 91 by way of a double-sided tape, thus fixing the multiple bodies 30 on the peripheral wall 91 so as to decorate the peripheral wall 91.

3. The body 30 includes the prepolymer PU leather layer 10 and the PU foaming substrate 20 which are foam molded, such that the body 30 is thin. Preferably, a thickness of a minimum cross section of the body 30 is 0.52 cm, i.e., the thickness of the prepolymer PU leather layer 10 is 0.02 cm, and the thickness of the PU foaming substrate is within 0.02 cm to 0.5 cm.

4. The prepolymer PU leather layer 10 and the PU foaming substrate 20 are made of polyurethane material and are foam molded to produce the body 30, wherein the holder 50 is heated at the temperature of 30° C. to 40° C. so that the prepolymer PU leather layer 10 is adhered with the PU foaming substrate 20 matingly.

5. The prepolymer PU leather layer 10 has ductility, and the PU foaming substrate 20 has expansibility, so the thickness of the prepolymer PU leather layer 10 is within 0.2 mm to 0.5 mm, and the density of the PU foaming substrate 20 is within 0.2 g/cm³ to 0.29 g/cm³ so that the body 30 is formed after the prepolymer PU leather layer 10 and the PU foaming substrate 20 connects together, and the prepolymer PU leather layer 10 matches with the PU foaming substrate 20 well. The foam mold 40 includes the first radian 52 and the second radian 61 which are configured to form the body 30 with said another first radian 52 of the prepolymer PU leather layer 10 and said another second radian 61 of the PU foaming substrate 20, wherein the body 30 is curved and then is flatten after a period of foam molding time so as to avoid wrinkles on the prepolymer PU leather layer 10 and a curved bottom of the PU foaming substrate 20.

6. The air channel 54 surrounds the cavity 51, wherein the air channel 54 has the successive arcuations arranged therein so as to exhaust the air out of the PU foaming substrate 20 via the air channel 54, such that the prepolymer PU leather layer 10 or the PU foaming substrate 20 does not wrinkle or does not protrude.

7. The first fixture 70 of the foam mold 40 fixes the cover 60, and the second fixture 80 clamps the press flange 59, such that when the PU foaming substrate 20 inflates, the cover 60 covers the foam mold 40 securely, and the prepolymer PU leather layer 10 is fixed in the cavity 51 of the holder 50 firmly.

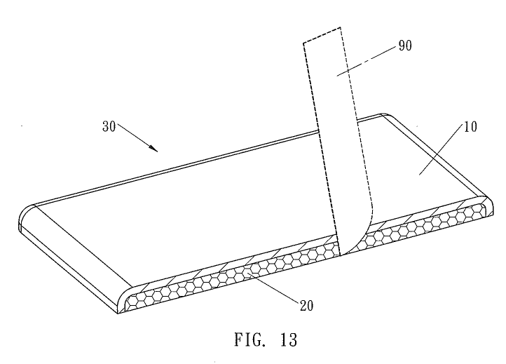

8. As illustrated in FIGS. 13 and 14, the multiple wall panels 30 are thin and are in any one of a square shape, a rectangle shape, a circle shape, a triangle shape, and a rhombus shape. Thereby, the multiple bodies 30 decorate the peripheral wall 91. Preferably, a part of each of the multiple bodies 30 is cut by the cutter 90 so as to form a cut portion 301 of said each body 30, and the cut portion 301 is adhered on the peripheral wall 91 based on using requirements.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A method of making a foam wall panel comprising:
melting and adhering a prepolymer PU leather layer with a peripheral fence and a top of a polyurethane (PU) foaming substrate by using a foam mold so as to form a body in a geometry shape and with a thin thickness;
wherein the prepolymer PU leather layer has a thickness of 0.2 mm to 0.5 mm;
wherein the polyurethane (PU) foaming substrate has a density of 0.2 g/cm³ to 0.29 g/cm³;
wherein the PU foaming substrate is within 0.5 cm to 2 cm after the foam wall panel is formed;
wherein the foam mold includes a holder which has a cavity defined on a central portion thereof, a first radian formed on a bottom of the cavity, a plurality of orifices arranged under the bottom of the cavity, and an air channel surrounding the cavity, wherein the air channel has successive arcuations arranged therein so as to exhaust air and to accommodate a part of the PU foaming substrate;
wherein a cover is rotatably connected with a first end of the holder, and the cover includes a second radian corresponding to the cavity, when foam molding the body, the plurality of orifices suck the prepolymer PU leather layer on the bottom of the cavity, and the first radian and the second radian correspond to a deformation of the PU foaming substrate, such that a first surface of the body corresponds to the first radian and a second surface of the body corresponds to the second radian so as to compensate the deformation of the PU foaming substrate.

2. The method as claimed in claim 1, wherein the foam mold is heated at a temperature of 30° C. to 40° C. in an electronic controlling manner.

3. The method as claimed in claim 1, wherein a depth of the air channel corresponds to the thickness of the prepolymer PU leather layer.

4. The method as claimed in claim 1, wherein the foam mold further includes a groove formed in the holder and communicating with the plurality of orifices, and the groove is in connection with a first end of a guide tube, wherein a second end of the guide tube is coupled with a vacuum apparatus.

5. The method as claimed in claim 1, wherein the foam mold further includes a first fixture disposed on a second end of the holder opposite to the first end of the holder and configured to fix the cover, after the cover covers the holder.

6. The method as claimed in claim 1, wherein the cavity has a pattern section formed on the bottom thereof, and a depth of the pattern section is within 0.5 mm to 2 mm.

7. The method as claimed in claim 1, wherein the foam mold further includes a press flange rotatably connected with a first peripheral side of the holder between the first end and the second end of the holder, and a shape of the press flange corresponds to a peripheral portion of a top of the holder adjacent to a top of the cavity so that the press flange covers and presses the peripheral portion of the top of the holder.

8. The method as claimed in claim 7, wherein the cover also includes a protrusion arranged on a bottom thereof, and the second radian forms on the protrusion.

9. The method as claimed in claim 7, wherein the foam mold further includes a second fixture mounted on a second peripheral side of the holder opposite to the first peripheral side of the holder so as to clamp the press flange, after the press flange covers the holder.
